(19) United States
(12) Patent Application Publication
(10) Pub. No.: US 2010/0306308 A1
(43) Pub. Date: Dec. 2, 2010

(54) SCALABLE SYSTEM FOR RESOURCE MANAGEMENT AND/OR RESOURCE ALLOCATION BASED ON ONLINE CONSTRAINT SATISFACTION SOLVING

(76) Inventor: Zaher Andraus, Ann Arbor, MI (US)

Correspondence Address: CHRISTOPHER P. MAIORANA, P.C., 24840 HARPER SUITE 100, ST. CLAIR SHORES, MI, 48080, US

(21) Appl. No.: 12/475,765

(22) Filed: Jun. 1, 2009

(51) Int. Cl. G06F 15/16; G06F 7/06; G06F 17/30

(52) U.S. Cl. 709/203; 707/E17.014; 709/201

(57) ABSTRACT

A system comprising a first module and a second module. The first module may be configured to generate (i) a first set of data stored internally and (ii) a second set of data configured to be processed externally, each in response to an input signal. The second set of data may contain information about a problem to be solved without disclosing confidential information. The second module may be configured to (i) process said second set of data internally when in a first mode and (ii) distribute the second set of data to one or more external processors when in a second mode.

### FIELD OF THE INVENTION

The present invention relates to constraint solving generally and, more particularly, to a method and/or architecture for implementing a scalable system for resource management and/or resource allocation based on online constraint satisfaction solving.

### BACKGROUND OF THE INVENTION

Instances of resource management and allocation (RMA) arise during the operation of numerous processes and/or organizations. These processes and/or organizations can include transportation and logistic companies, schools, universities, other educational institutions, hospitals, factories, and airports. Resource management and allocation can be implemented anywhere human resources (i.e., instructors, drivers, service providers, etc.), physical resources (i.e., equipments, components, etc.), virtual resources (i.e., computation processes on a multi-core system etc.), and objects (i.e., intersecting phrases in word games) are managed and/or allocated. A content management aspect of allocation can be traditionally implemented with proper hardware and software. However, a true challenge is the need for formulating and efficiently computing one or more optimal solutions that correspond to a desired allocation subject to a set of constraints. Current problems include those problems that are theoretically defined as NP-complete or NP-hard (i.e., those problems without a known polynomial-time solving algorithm). These problems can belong to one or more categories of scheduling, routing, graph algorithms, search algorithms, genetic algorithms, hardware and software exhaustive testing/verification, and/or other discrete optimization problems.

Conventional approaches to solve these challenges incorporate two main components—a caller and a solver. The caller refers to an interface (or a data). The interface allows a user to define the problem to the solver. The interface can be a user interface or a direct interface to an embedded software or hardware solution. The data refers to the database that stores (or content manages) the input problem that is passed to the solver. The solver (or solving method) takes the input problem and produces one or more solutions (or proves/diagnoses the lack of a solution).

Traditionally, the caller and solver reside on the same hosting hardware. The user of the caller is generally concerned about the safety of the database (or collection of information) from which the problem is specified. In one example, the caller and solver reside in the same hosting hardware because the solver does not need heavy computational resources. For example, a school principal that is concerned with a database containing the names and availability of teachers might want the caller and solver residing in the same hosting hardware. Therefore, timetabling software has traditionally been delivered as a self-contained desktop application that includes the caller and the solver operating in the same hosting hardware.

Since RMA challenges are very difficult computationally, a sensible architecture would place the solver on a powerful machine and/or network server(s). An example of such an approach has been adopted by the NetSolve/GridSolve project (i.e., GridSolve). Users' Guide to NetSolve v1.4.1, ICL Technical Report, ICL-UT-02-05, Jun. 25, 2002 is hereby incorporated in its entirety. However, GridSolve was designed for scientific use, rather than commercial use. Placing both the caller and solver on remote machines, as done in GridSolve, is a less secured solution for commercial users, and is thus less desirable. Even with the presence of a secured network link between the user and servers (and/or secured hosting servers), users are reluctant to use such configurations.

It would be desirable to implement a method and/or architecture for implementing a scalable system for resource management and allocation based on online constraint satisfaction solving.

### SUMMARY OF THE INVENTION

The present invention concerns a system comprising a first module and a second module. The first module may be configured to generate (i) a first set of data stored internally and (ii) a second set of data configured to be processed externally, each in response to an input signal. The second set of data may contain information about a problem to be solved without disclosing confidential information. The second module may be configured to (i) process said second set of data internally when in a first mode and (ii) distribute the second set of data to one or more external processors when in a second mode.

The objects, features and advantages of the present invention include providing a scalable system for resource management and/or resource allocation based on online constraint satisfaction solving that may (i) store sensitive data locally, (ii) provide a subset of the data to be distributed to a network resource, (iii) implement the subset of data to remove sensitive data, and/or (iv) be implemented to keep sensitive data secure.

### BRIEF DESCRIPTION OF THE DRAWINGS

These and other objects, features and advantages of the present invention will be apparent from the following detailed description and the appended claims and drawings in which:

FIG. 1 is a flow diagram illustrating satisfiability (SAT) solving;

FIG. 2 is a flow diagram illustrating conjunctive normal form (CNF) solving;

FIG. 3 is a flow diagram illustrating maximum-satisfiability (MAX-SAT) solving with an off-the-shelf solver;

FIG. 4 is a block diagram of an embodiment of the present invention;

FIG. 5 is a more detailed block diagram of an embodiment of the present invention;

FIGS. 6(A-B) are a flow diagram illustrating an embodiment of the present invention;

FIG. 7 is a flow diagram illustrating another embodiment of the present invention;

FIG. 8 is a flow diagram illustrating another embodiment of the present invention;

FIG. 9 is a flow diagram illustrating another embodiment of the present invention; and

FIG. 10 is a block diagram of an embodiment of the present invention.

### DETAILED DESCRIPTION OF THE PREFERRED EMBODIMENTS

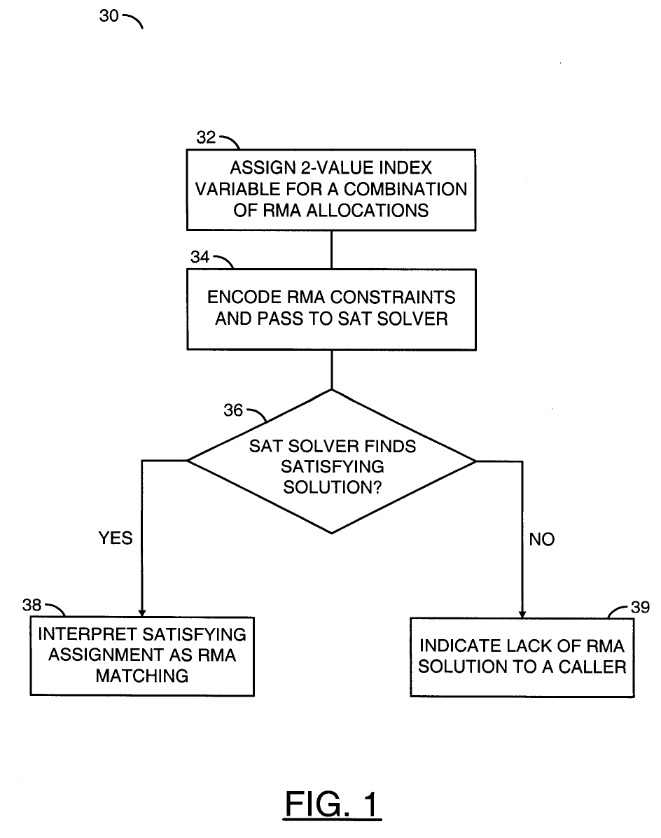

Referring to FIG. 1, a flow diagram illustrating a process 30 is shown. The process 30 generally comprises a state 32, a state 34, a decision state 36, a state 38 and a state 39. The state 32 assigns a 2-value index variable for a combination of resource management and allocation (RMA) allocations. The state 34 encodes the RMA constraints and passes the encoded constraints, using the 2-value index variables, to a satisfiability (SAT) solver. The decision state 36 uses the SAT solver to find one or more satisfying solutions. If a satisfying solution is found, the process 30 moves to the state 38. If not, the process 30 moves to the state 39. The state 38 interprets a satisfying assignment as an RMA matching. The state 39 indicates the lack of a RMA solution to a caller.

The process 30 may be implemented in a computerized system for solving RMA problems. The process 30 may be used in a local dedicated computer. The process 30 may use a constraint satisfaction problem (CSP) formulation with a 2-value Boolean variables (e.g., variables that may be assigned only a 0 or a 1). The CSP formulation may be referred to as satisfiability solving (SAT).

The process 30 illustrates an implementation for solving resource management and allocation using ILP formulations. These methods are generalizations to satisfiability (SAT) solving. Other methods may be implemented for solving RMA using standard SAT solvers. These methods use the well-known conjunctive normal form (CNF) formulation (e.g., a conjunction of so-called clauses, where each is a disjunction of literals, which are Boolean variables or their negation). For example, two clauses (e.g., (A or B) and (A′ or B or C′)) may be conjoined to form a CNF instance, where X′ may denote the Boolean negation of X.

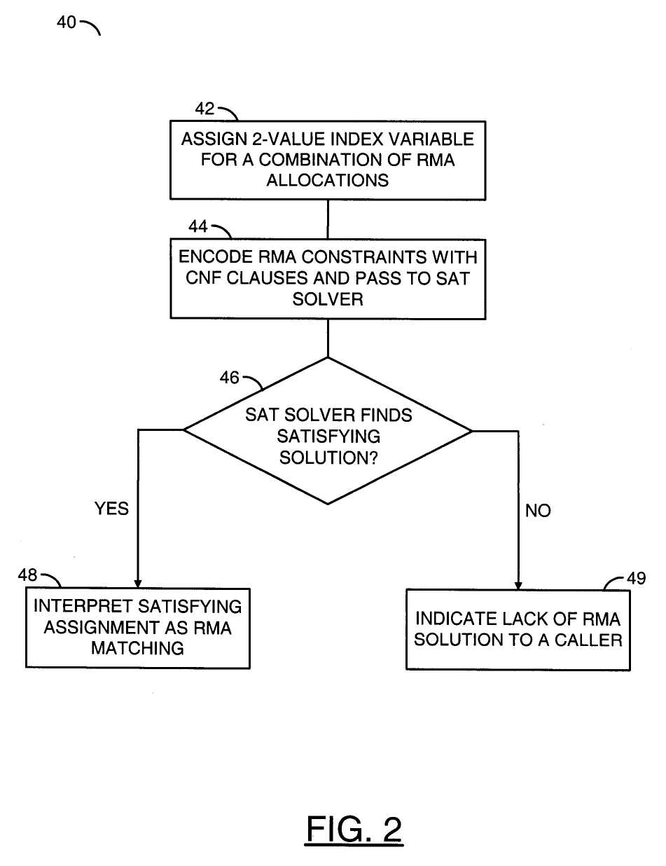

Referring to FIG. 2, a flow diagram illustrating a process 40 is shown. The process 40 generally comprises a state 42, a state 44, a decision state 46, a state 48 and a state 49. The state 42 assigns a 2-value index variable (e.g., a constraint) for a combination of resource management and allocation (RMA) allocations. The state 44 encodes the RMA constraints with conjunctive normal form (CNF) clauses and passes the encoded constraints to a satisfiability (SAT) solver. The decision state 46 uses the SAT solver to find one or more satisfying solutions. If a satisfying solution is found, the process 40 moves to the state 48. If not, the process 40 moves to the state 49. The state 48 interprets a satisfying assignment as an RMA matching. The state 49 indicates a lack of an RMA solution to a caller.

First, a 2-value Boolean variable (e.g., a constraint) may be assigned to represent a “matching” of a certain resource with a certain consumer, in a certain slot, with certain attributes. For example, a Boolean variable (e.g., X(T,J,C,S)) may be set as 1 if, and only if, teacher T teaches subject J in class C in slot S. Auxiliary Boolean variables may be used to facilitate defining the relation between the variables. Variables may be indexed with a running index, according to a one-to-one mapping function, that maps a combination of selections of the problem elements to the running index. Next, the RMA constraints may be represented with conjunctive normal form (CNF) clauses. Next, the CNF formulation may be passed to a solver (e.g., a DPLL-solver) that may find a solution (e.g., assignment to the variables) or indicate the lack of a solution. A Computing Procedure for Quantification Theory, Journal of the Association for Computing Machinery, vol. 7, no., pp. 201-215, 1960, A Machine Program for Theorem-Proving, Communications of the ACM, vol. 5, no. 7, pp. 394-397, 1962, and DPLL(T): Fast Decision Procedures, 16th International Conference on Computer Aided Verification (CAV), July 2004, Boston (USA) are hereby incorporated in their entirety.

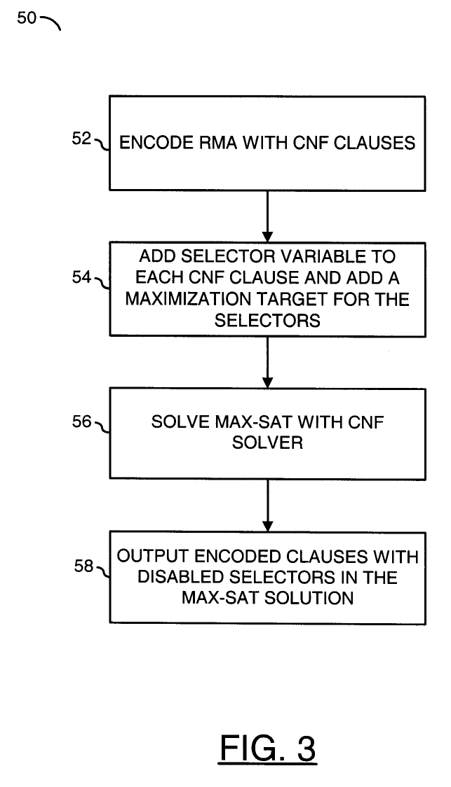

Referring to FIG. 3, a flow diagram illustrating a process 50 is shown. The process 50 generally comprises a state 52, a state 54, a state 56 and a state 58. The state 52 may encode a resource management and allocation (RMA) allocation with conjunctive normal form (CNF) clauses. The state 54 may add a selector variable to each clause. The state 54 may also add a maximization target for the selectors. The state 56 may solve a maximum satisfiability (MAX-SAT) with a CNF solver. The state 58 may present an output (e.g., the encoded clauses) with disabled selectors in the MAX-SAT solution.

If a SAT solver indicates that an RMA instance is infeasible, the user is faced with a dilemma (e.g., what to do next?). The process 50 is based on a MAX-SAT formulation (e.g., finding the maximal number of constraints that are satisfiable in an UNSAT instance). An implementation of MAX-SAT via off-the-shelf CNF SAT solvers may rely on a set of selector variables. For example, each clause cᵢ may be replaced with a clause (e.g., sᵢ->cᵢ by disjoining the existing literals of the clause with sᵢ′), and the SAT solver may be asked to maximize a target (e.g., s₁₊ s_{2+ . . . +} sₖ), where k is the number of constraints in the system. When sᵢ is equal to 1, the clause may be active and behave similarly to its role in the original problem. When sᵢ is equal to 0, the clause is not active, and may be implicitly removed from the SAT problem.

The solution to this problem (which always exists) is an assignment to the selector variables, determining which clauses are selected to be included (e.g., selector variable is 1) and which are not (e.g., selector variable is 0), such that the maximal number of clauses is satisfied by some assignment to the original problem formulation. The clauses that are excluded from the MAX-SAT solution may lead to a contradiction in the RMA instance that may disallow any feasible solution to the problem.

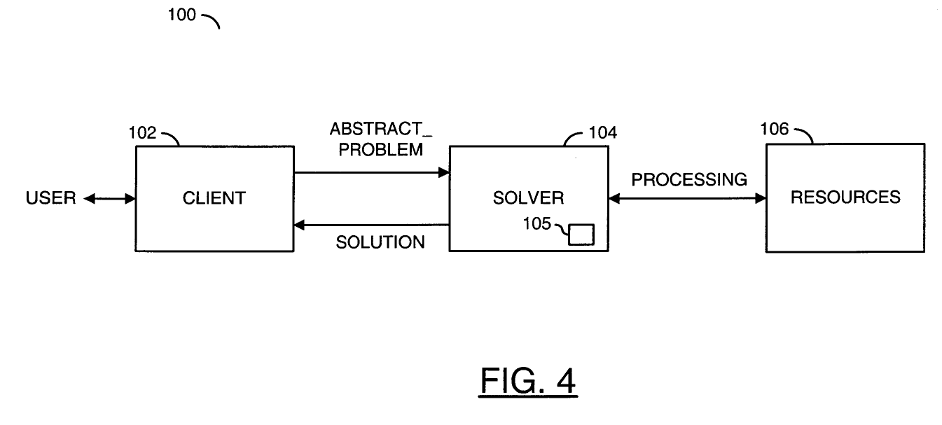

Referring to FIG. 4, a block diagram of the system 100 is shown. The system 100 generally comprises a block (or module) 102, a block (or module) 104, and a block (or module) 106. The block 102 may be implemented as a client block (or application). The block 104 may be implemented as a solver block (or application). The block 106 may be implemented as a resource block (or application). The client application 102 may receive information from a user. The client application 102 may filter confidential information from a problem received from the user. The confidential information may be stored within the client application 102. By keeping the confidential information within the client application 102, the overall operation of the system 100 would normally be secure. The client application 102 is not normally directly accessible over a public network. The modules 102, 104, and 106 may be implemented as software, hardware, or a combination of hardware and software.

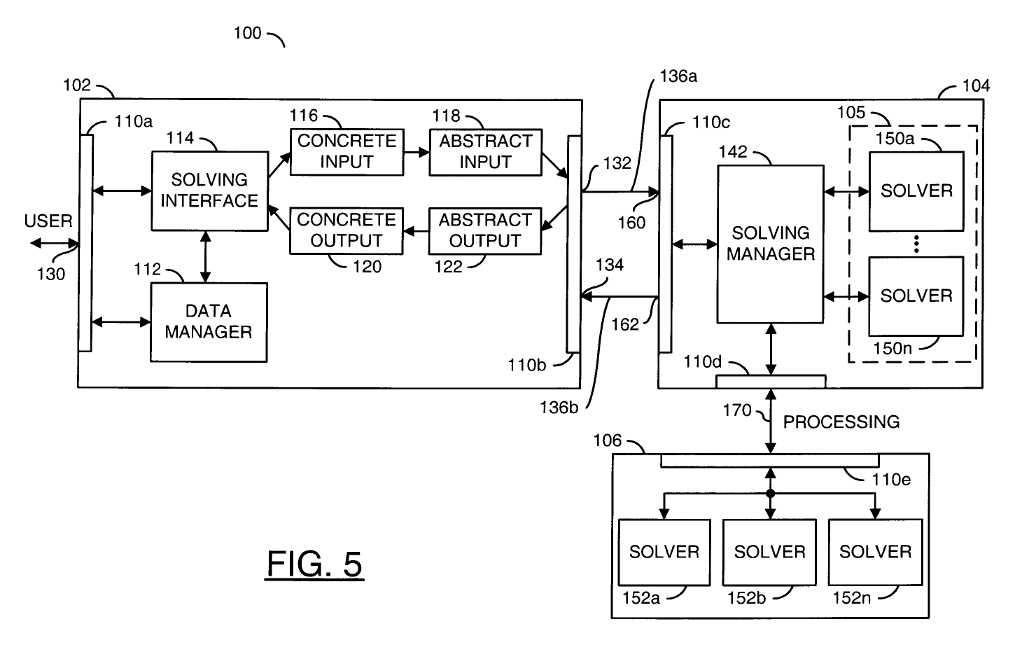

The client application 102 may generate a signal (e.g., ABSTRACT_PROBLEM) that may be sent to the solver application 104. The signal ABSTRACT_PROBLEM may represent a subset of data that does not include any confidential information (to be described in more detail in connection with FIGS. 5-9). The data stored in the signal ABSTRACT_PROBLEM may contain original information to process the problem.

The solver application 104 may include a resources (or processing) block (or module) 105. The processing block 105 may include one or more processors that are internal to the solver application 104. The solver application 104 may determine whether to distribute portions of the problem to the resources block 105, to the resources block 106, or a combination of the resources block 105 and/or the resources block 106. One example, the solver application 104 may be a server computer stored on a secured network along with the client application 102. In certain applications, it may be desirable to process the problem entirely on the solver application 104. In particular, a fee may be associated with using the resources block 106. The solver application 104 may determine that the internal resources block 105 has sufficient resources to process the problem without sending information to the resources block 106.

Other examples of dividing the problem between the resources block 105 and the resources block 106 may be implemented. For example, the resources block 106 may have certain times of the day during low use where problems can be solved much faster. The solver application 104 may exploit such resource rich times in such a way to increase the overall processing of the system.

The solver application 104 may generate a signal (e.g., PROCESSING) that may be sent/received to/from the resources block 106. The signal PROCESSING may be a bidirectional signal that sends one or more portions of the problem to the resources block 106, then receives a solution from the resources block 106. The solver application 104 may distribute the problem to one or more processors (or solvers) within the resources block 106. The solver application 104 may present a solution through a signal (SOLUTION) back to the client application 102.

Referring to FIG. 5, a more detailed block diagram of the system 100 is shown. The client side application block 102 generally comprises a block (or module) 110a, a block (or module) 110b, a block (or module) 112, a block (or module) 114, a block (or module) 116, a block (or module) 118, a block (or module) 120, and a block (or module) 122. The block 110 may be implemented as a user interface. The block 112 may be implemented as a data manager. The block 114 may be implemented as a solving interface. The block 116 may be implemented as a concrete input block. The block 118 may be implemented as an abstract input block. The block 120 may be implemented as a concrete output block. The block 122 may be implemented as an abstract output block. The block 110b may be implemented as a network interface block.

The user interface 110a may have an input 130 that may receive commands from a user. The network interface 110b may have an output 132 that may present information to the solver block 104. The network interface 110b may also have an input 134 that may receive information from the solver block 104. The input 132 and the output 134 may communicate with the solver block 104 through a network link 136a and/or a network link 136b. The particular type of network link may be varied to meet the design criteria of a particular implementation.

The solver block 104 generally comprises a block (or module) 110c, the block 105, a block (or module) 142, and a block (or module) 110d. The block 110c may be implemented as a network interface. The block 142 may be implemented as a solving manager block. The network interface 110c may present information through the network link 136b. Similarly, the network interface 110c may have an input 160 that may receive information through the network link 136a. The processing block 105 generally comprises a number of blocks (or modules) 150a-150n. The blocks 150a-150n may be implemented as solver blocks.

The resources block 106 generally comprises a number of blocks (or modules) 152a-152n and a block (or module) 110e. The blocks 152a-152n may be implemented as solver blocks. The resources block 106 may connect to the solver block 104 through the network interface 110e. The interface 110d and the interface 110c may be connected through a link 170. The solver block 104 may distribute problems to the resources block 106. In one example, the resources block 106 may be implemented as one or more processors (e.g., servers, etc.) located separately from the solver block 104.

The interface block 110a may interact with the user through a terminal and/or other appropriate computerized system with I/O ports. For example, the user interface block 110a may interact visually with a user. The user interface block 110a may manage content by interacting with the data manager block 112. The user interface block 110 may delegate resource management and allocation (RMA) solving to the solving interface block 114. The data manager 112 may be a data storage component that may interact with the user interface 110a and the solving interface 114. The solving interface 114 may include a database that may be stored locally (e.g., on a client) or a database that may be stored on a dedicated server belonging to the user.

The solving interface 114 may include computation logic for facilitating the solving process. The solving interface 114 may (i) assist the user in manually solving the RMA problem, (ii) alert the user of issues that may prevent or affect solving the RMA, and/or (iii) launch and manage remote RMA solving by (a) creating a concrete RMA formulation (e.g., a concrete input) that may represent an optimization problem based on the actual data received from the user (e.g., a distillation of all information relevant to solving the RMA problem), (b) stripping away the actual data (e.g., the concrete input) and creating an abstract input that may be safely sent to a remote solver without compromising the data, (c) communicating the abstract input to a network interface, (d) receiving the abstract output and concretizing the abstract output, and/or (e) communicating the final solution with the user interface for final display.

The solving manager 142 may launch instances of the solver blocks 150a-150n that may be used to solve the RMA problem and/or coordinate the results. The solving manager 142 may (i) automatically manage the allocation/de-allocation of computational nodes (e.g., dedicated processors) based on an utilization of the currently running processes, (ii) include those in a Cloud Computing pool with load balancing controllers, Gruman, Galen: What Cloud Computing Really Means, InfoWorld, Apr. 4, 2007, retrieved on Jan. 1, 2009, is hereby incorporated in its entirety, (iii) track the results of all the solver instances that are dedicated to solving the same problem, and (iv) terminate/initialize a number of processes if needed. In one example, the solving manager 142 may be implemented in two modes (e.g., a competition mode and a cooperation mode). In the competition mode, the solving manager 142 may launch one or more of the solvers 150a-150n on the same RMA problem. The solvers 150a-150n may run different solving processes and/or similar processes with various implementations and/or solving heuristics. Once one of the solvers 150a-150n terminates (indicating a solution or a lack of a solution), all the solvers 150a-150n may be terminated. The solvers 150a-150n may be freed, and the result may be communicated back to the caller (e.g., the block 102). In the cooperation mode, the solving manager 112 may launch one or more of the solvers 150a-150n that may each try to solve a different part of the problem (e.g., sub-spaces of the overall space of the RMA). Parallel Propositional Satisfiability Checking with Distributed Dynamic Learning, Parallel Computing 29 (2003) 969-994, A Distributed Propositional Prover and Its Application to Quasigroup Problems, Journal of Symbolic Computation 11 (1996) 1-18, and A Parallel SAT Solver for the Grid, UCSB Computer Science Technical Report (2003) are hereby incorporated in their entirety.

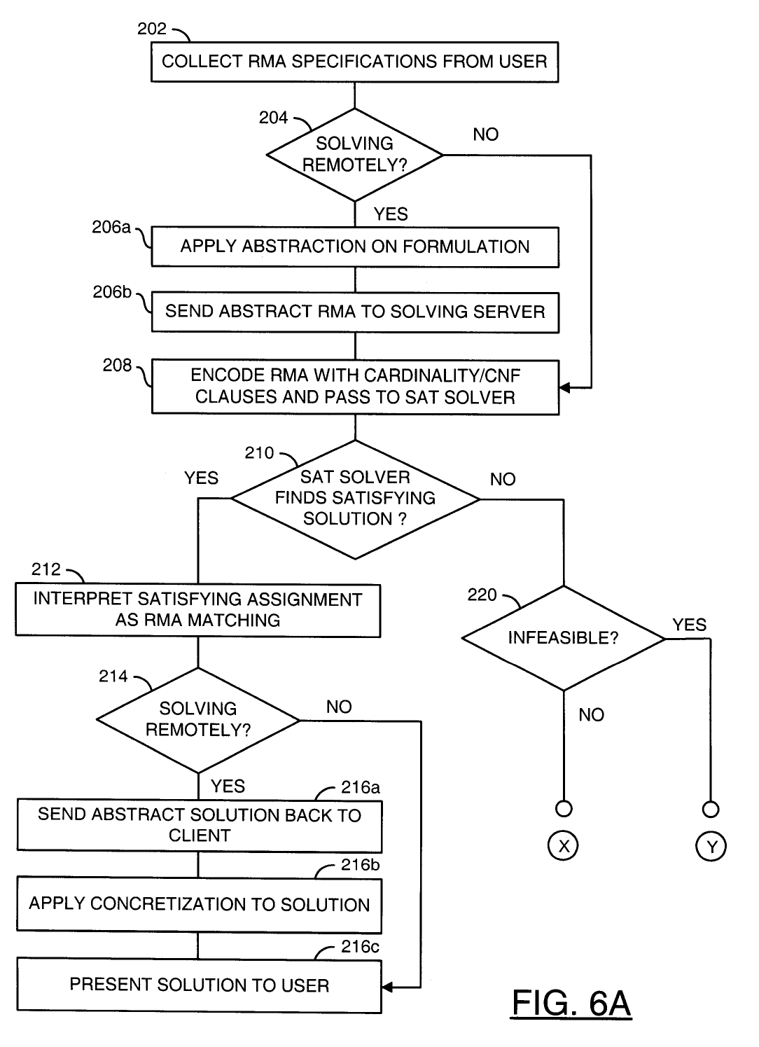

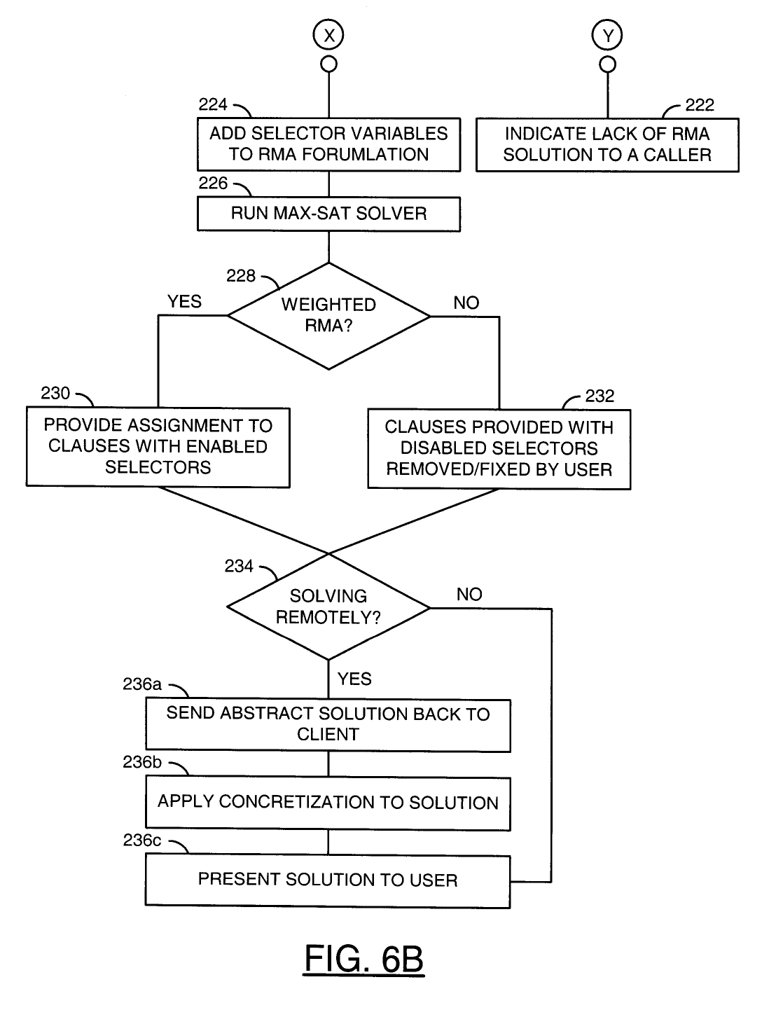

The software implementations of solving process, as well as methods for analyzing infeasibility, are described further in more detail in connection with FIGS. 6-10. The network interfaces 110a, 110b, 110c, 110d and 110e (or client-server communication) may allow the data communication to be implemented, among other ways, with XML-like transmission over a LAN, WAN, and/or World Wide Web network.

The system 100 may implement a hybrid approach that combines the merits of the “secure” traditional approach with the “scalable” GridSolve approach. In the system 100, the caller 102 may be local with respect to the user (or owner) while the solvers 150a-150n may be remote. To enable the physical separation between the data (e.g., stored in the caller) and the solvers 150a-150n, the caller 102 may “synthesize” an abstract representation of a challenge to be solved. The synthesized challenge may be implemented to mask the sensitive data. The synthesized challenge may also include sufficient information that may allow the solvers 150a-150n to incorporate the same techniques (e.g., algorithmic variations, heuristics, etc.) that the solvers 150a-150n would have used if the solvers 150a-150n had the full specification of the problem. In one example, the synthesis process may strip the data from the input problem and create an abstract version of the data (e.g., “abstraction”). Such a synthesis process is normally possible in most discrete optimization problems. The dual process of abstraction (e.g., “concretization”) may take the abstract solution received from the solver and embed data in the abstract solution. The updated abstract solution may then become meaningful for the original problem specified by the caller 102.

Since the caller 102 may be stored locally, a user data may be secured and/or managed locally. Furthermore, potential losses that may occur when a network link is not functioning (and the solver is not available) may be minimized. The user may temporarily continue the content management locally, which may not need the resources block 106. The resources block 106 may reside on a dedicated hardware (e.g., a hosting machine). In one example, such a hosting machine may be significantly more powerful (or specialized) for solving the desired challenge. The hosting machine may provide a faster solving time and/or more efficiency in terms of the user. The hosting machine may be more efficient since no resources are being used on the user end. The hosting machine may also incorporate two or more machines that may try to solve the same problem with different variations of processing, and/or specialized software, and/or hardware.

The following describes how the system 100 may achieve solutions for a special case of resource management and allocation (RMA), namely school timetabling. Similar derivations may be obtained for other instances of RMA. The system 100 may also be implemented for solving RMA problems in a manner that efficiently (e.g., from a time-wise perspective) produces solutions that comply with a variety of constraints, and thus more optimal allocations in terms of resources. The system 100 may be based on formulating RMA as the satisfaction (or satisfiability) of a set of cardinality constraints and a set of Boolean constraints. The constraints may be passed to a satisfiability (SAT) solver (e.g., a DPLL-solver) with watch literals and decision heuristics.

The system 100 may produce one or more subsets of the constraints specified in the RMA formulation, which may be removed, relaxed, tightened, and/or modified in various ways in order to turn an infeasible RMA instance into a feasible RMA instance. The system 100 may assist the user in modifying an unsolvable RMA instance in order to produce a solution. The system 100 may also be incorporated in an iterative RMA method that automatically adjusts the RMA instance in order to ultimately find a solution to a subset of constraints that best satisfies a priority mechanism dictated by the user.

Two implementations of the system 100, namely solving RMA instances efficiently and identifying causes for infeasibility, contribute to the overall system solution disclosed, but may also be used independently of the client-server architecture (e.g., when solving RMAs on a local dedicated machine).

Referring to FIGS. 6(A-B), a flow diagram of a method (or process) 200 is shown. The process 200 generally comprises a step (or state) 202, a decision step (or state) 204, a step (or state) 206, a step (or state) 208, a decision step (or state) 210, a step (or state) 212, a decision step (or state) 214, a step (or state) 216, a step (or state) 218, a decision step (or state) 220, a step (or state) 222, a step (or state) 224, a step (or state) 226, a decision step (or state) 228, a step (or state) 230, a step (or state) 232, a decision step (or state) 234, and a step (or state) 236. The state 202 may collect resource management and allocation (RMA) specifications from a user. The decision state 204 may determine whether the solution can be solved remotely. If so, the process 200 may move to the state 206. If not, the process 200 may move to the state 208. The state 206 generally comprises a first step A that may apply an abstraction on a formulation and a step B that may send an abstract RMA to the solving server. Next, the state 208 may encode the RMA with cardinality and conjunctive normal form (CNF) clauses and may pass the encoded RMA to a satisfiability (SAT) solver. Next, a decision state 210 may determine if the SAT solver finds one or more satisfying solutions. If so, the method 200 moves to the state 212. If not, the method 200 moves to the state 220. The state 212 interprets each satisfying assignment and an RMA matching. Next, a decision state 214 determines if the solution can be solved remotely. If so, the method 200 moves to the state 216. The state 216 generally comprises a first step A that may send an abstract solution back to a client, a step B that may apply concretization to the solution, and a step C that may present the solution to the user. If the decision state 214 determines that the problem cannot be solved remotely, the method 200 moves directly to the state 216c.

If the decision state 214 does not find one or more satisfying solutions, the method 200 moves to the decision state 220. The decision state 220 analyzes the step for infeasibility. If the solution is infeasible, the method 200 moves to the state 222. The state 222 may indicate a lack of RMA solution to the caller. If the decision state 220 determines the solution is feasible, the method 200 moves to the state 224 which adds selector variables to the RMA formulation. Next, the state 226 may run a maximum satisfiability (MAX-SAT) solver. Next, the decision state 228 determines if a weighted RMA is needed.

If not, the method 200 moves to the state 232. In the state 232, the user may remove (or fix) provided solution clauses with disabled selectors. If the decision state 228 determines a weighted RMA is needed, the method 200 moves to the state 230. The state 230 may provide an assignment to clauses with enabled selectors. Next, the decision state 234 may determine whether the solution can be solved remotely. If so, the method 200 moves to the state 236. The state 236 comprises a first step A that may send an abstract solution back to the client, a second step B that may apply concretization to the solution, and a third step C that may present a solution to the user. The states 236a, 236b and 236c are similar to the states 216a, 216b and 216c. If the decision state 234 determines a particular solution cannot be solved remotely, the process 200 moves directly to the state 236c.

Data abstraction may be used to reduce the amount of information passed over a network link to be as small as possible, yet detailed enough to allow the solver to tailor the best processing capability to the instance at hand.

In RMA instances, elements (e.g., producers or consumers of resources) are grouped into a number of finite sets. For example, timetabling may be concerned with a group of teachers, subjects, slots, classes, and class rooms. To perform abstraction, a detailed description of the RMA instance may be rendered and altered such that each element is replaced with an index. The index generally comprises two identifiers (e.g., a group index and a group-array index). The group index may determine the group to which the element belongs. The group-array index may determine an order of the element within a pre-defined order in the group that the caller chooses. The caller and the solver may agree on the order of the groups indexed by the group index. No agreement may be set for the group-array index between the caller and the solver. For example, the caller and the solver may be synchronized on the semantics of the group index allowing the solver to tailor various heuristics to certain groups rather than others. The caller may “mask” the semantics of the group-array indices from the solver, since not doing so would entail communicating sensitive information, and in turn compromising the data security requirement. Indexing for the groups and group-arrays should be a one-to-one function, in order to allow an inverse to be defined.

In one example, the caller 102 and the solver 104 may agree that the teachers, slots, and classes correspond respectively to a set of group indices (e.g., 1, 2, 3, etc.). The solver 104 may define an ordering for each teacher, slot, and class, and assign a group-array index for each element. In one example, the group-array index may be Sam=1, Adam=2, Bob=3, 8AM=1, 9AM=2, 10AM=3, 11AM=4, 12PM=5, and First Grade=1, Second Grade=2, Third Grade=3.

Abstraction may then be performed by the caller 102. The caller 102 may replace each occurrence of a teacher, slot, or a class with an index based on the group index and group-array index of the element. For example, relating teachers to classes may be described with the following relations, Sam teaches First Grade in 2 slots overall, Adam teaches First Grade in 1 slot overall, and Second Grade in 2 slots overall. The abstract correspondence of this may be (1,1) teaches (3,1) in 2 slots overall, (1,2) teaches (3,1) in 1 slot overall and (3,2) in 2 slots overall.

The abstract representation may be communicated to the solving manager 142. The solving manager 142 may return an abstract solution. For example, the abstract solution may be (1,1) teaches (3,1) in (2,1) and (2,2), (1,2) teaches (3,1) in (2,3) and (3,2) in (2,4). By applying the inverse of the abstraction (e.g., indexing) function, the concrete solution may be obtained. An example of an inverse of the abstraction function may be that Sam teaches First Grade at 8AM and 9AM, Adam teaches First Grade at 10AM and Second Grade at 11AM.

An alternative indexing method may use a single index (e.g., a combined index) per element, without communicating two explicit indices per element. For example, the indexing may be Sam=1, Adam=2, Bob=3, 8AM=4, 9AM=5, 10AM=6, 11AM=7, 12PM=8, First Grade=9, Second Grade=10, Third Grade=11. In this example, the group index agreed to by the caller 102 and the solver 104, is implicit. Group indices may be retrieved using a function that the caller 102 and the solver 104 agree on. For example, the function may return a group (e.g., Group 1) for the combined indices 1, 2, and 3, since these elements belong to the same group.

The identifiers used to index groups and arrays may be any symbols that may be distinguished and/or ordered by the caller 102 and the solver 104. For example, alphanumeric symbols may be used as identifiers. The abstraction method may not be suitable when one of the groups may not be described as a set of discrete elements. For example, if the scheduling of a task may happen at “any time”, then the task may only be represented with real numbers. Real numbers may not normally be abstracted. In this example, the abstraction method may still be used on a version of the problem that is the closest to discrete. For example, time may be divided to standard units (e.g., seconds, hours, etc.) or any other quantity suitable for the RMA instance.

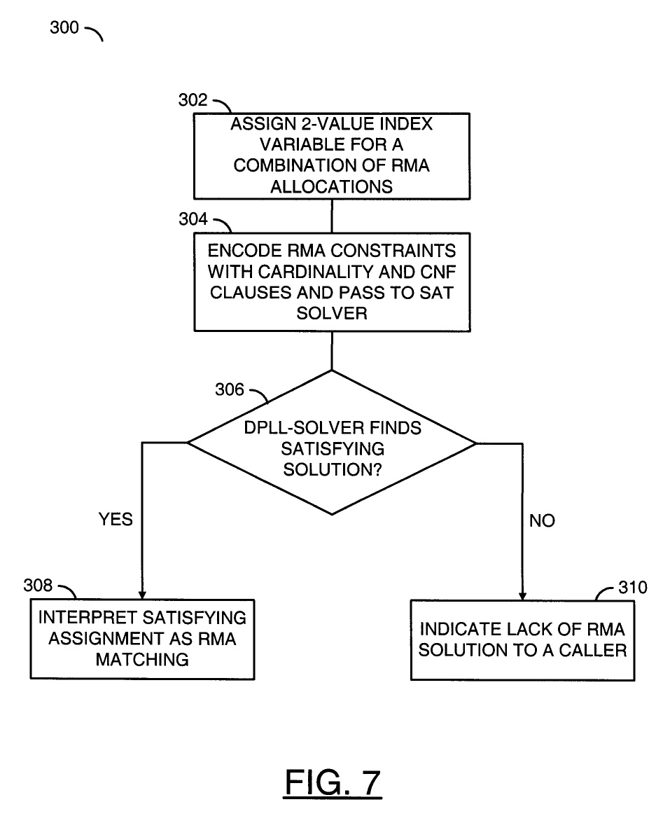

Referring to FIG. 7, a flow diagram illustrating a process 300 is shown. The process 300 generally comprises a step (or state) 302, a step (or state) 304, a decision step 306, a step (or state) 308 and a step (or state) 310. The state 302 may assign a 2-value index variable (e.g., a constraint) for a combination of resource management and allocation (RMA) allocations. Next, the state 304 may encode the RMA constraints with cardinality and conjunctive normal form (CNF) clauses and may pass them to a satisfiability (SAT) solver (e.g., a DPLL-solver). Next, the decision state 306 may determine if one or more satisfying solutions are present. If so, the method 300 moves to the state 308. If not, the method 300 moves to the state 310. The state 308 may interpret the satisfying assignment as a RMA matching. The state 310 may indicate the lack of an RMA solution to the caller 102.

The constraints may be represented as CNF and cardinality clauses. Cardinality constraints require that the summation of a number of literals (e.g., variables or their negation) is less, equal, greater, less-or-equal, or greater-or-equal than an integer bound. For example, A+B+C′<=2. The formulation may be passed to a SAT solver (e.g., a DPLL-solver) that may solve CNF and cardinality constraints.

Cardinality constraints may allow for a “counting” of the number of matched/allocated resources. Cardinality constraints may also directly impose constraints on the count. For example, to encode a fact that “Sam teaches First Grade 2 slots overall”, a cardinality constraint may be formulated by summing all Boolean variables corresponding to X(Sam,Jᵢ,First Grade, Sⱼ) for all subjects Jᵢ and slots Sⱼ in the system, and requiring that it is equal to 2. In another example, to require that “First Grade has at least one teacher in each slot”, a similar constraint may be used by summing all variables corresponding to that teacher in any class, and requiring the sum to be greater-or-equal to one.

Cardinality constraints naturally appear in numerous RMA instances. For example, a user may convert cardinality constraints into a CNF constraint prior to passing them to the SAT solver, causing an exponential increase of the SAT instance. In the present method, the cardinality constraints may be natively used and supported by DPLL-based SAT solvers without conversion to a CNF constraint. While other types of constraints may be used in the SAT formulation, the use of cardinality constraints is sufficient to solve a wide variety of RMA instances. Finally, SAT solvers (e.g., a DPLL-solver) support a watch literal and learning/non-chronological back-tracking for CNF constraints as well as cardinality constraints, making them easily integrated in a DPLL framework. GRASP: A Search Algorithm for Propositional Satisfiability, IEEE Transactions on computers, 1996, Chaff: Engineering an Efficient SAT Solver, Proceedings of the 38th Design Automation Conference, IEEE, 2001, and U.S. Pat. No. 7,418,369, are hereby incorporated in their entirety.

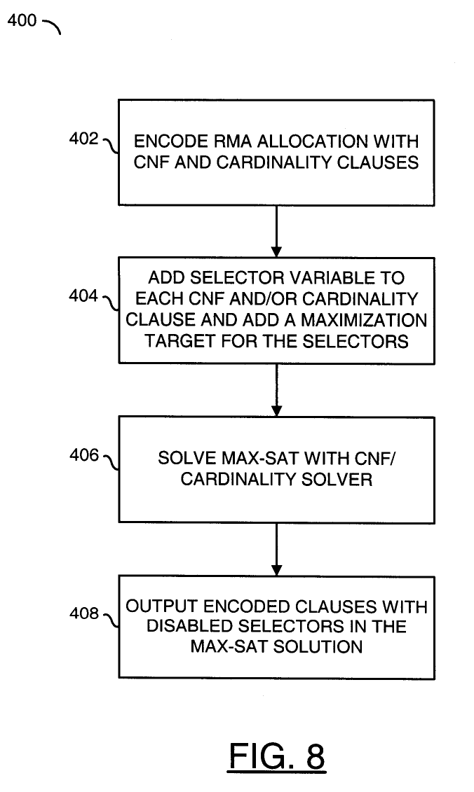

Referring to FIG. 8, a flow diagram illustrating a process 400 is shown. The process 400 generally comprises a step (or state) 402, a step (or state) 404, a step (or state) 406 and a step (or state) 408. The state 402 may encode a resource management and allocation (RMA) allocation with conjunctive normal form (CNF) and cardinality clauses. The state 404 may add a selector variable to each group of clauses (e.g., the cardinality clause and the CNF clause). The state 404 may also add a maximization target for the selectors. The state 406 may solve a maximum satisfiability (MAX-SAT) with a CNF/cardinality solver. The state 408 may present an output (e.g., the encoded clauses) with disabled selectors in the MAX-SAT solution.

Cardinality-based RMA works by using a modified procedure in the state 404. One selector variable may be allocated for each set of cardinality constraints representing the same RMA constraint. Each constraint may be modified to add a selection according to the type of the constraint. For example, a CNF clause may add the selector previously discussed. In another example, a cardinality clause may add the component Ms′ to the summation (e.g., where M is an integer constant with a large magnitude, M is negative for less and less-or-equal type constraints, and negative otherwise). A large M may indicate any constant whose value is strictly greater than the number of variables in the constraint.

The set of infeasibility causes (ICs) may be presented to the user. In one example, the user may eliminate these constraints and/or relax them in order to turn the RMA problem into a feasible problem. The user may re-invoke the RMA methods previously discussed.

For example, consider two RMA constraints for timetabling. First, Adam is absent on Monday. Second, Adam has more than 2 empty slots on Tuesday. The first RMA constraint may be encoded with the following CNF clauses:

X(Adam,Jᵢ,Cⱼ,S_{Monday}_{_{—}}_{8AM})=0;

X(Adam,Jᵢ,Cⱼ,S_{Monday}_{_{—}}_{9AM})=0;

X(Adam,Jᵢ,Cⱼ,S_{Monday}_{_{—}}_{1PM})=0.

The second RMA constraint may be encoded with the following CNF and cardinality clauses:

E(Adam,Jᵢ,Cⱼ,S_{Tuesday}_{_{—}}_{8AM})+E(Adam,Jᵢ,Cⱼ,S_{Tuesday}_{_{—}}_{9AM})+ . . . + E(Adam,Jᵢ,Cⱼ,S_{Tuesday}_{_{—}}_{1PM})>2;
X(Adam,Jᵢ,Cⱼ,S_{Tuesday}_{_{—}}_{8AM}) or . . . or X(Adam,J_{K},C_{N},S_{Tuesday}_{_{—}}_{8AM}) or E(Adam,S_{Tuesday}_{_{—}}_{8AM});
X′ (Adam,J₁,C₁,S_{Tuesday}_{_{—}}_{8AM}) or E′ (Adam,S_{Tuesday}_{_{—}}_{8AM})
X′ (Adam,J_{K},C_{N},S_{Tuesday}_{_{—}}_{8AM}) or E′ (Adam,S_{Tuesday}_{_{—}}_{8AM}).

The first constraint may describe the actual requirement using variables E, while the rest of the constraints may define the behavior of W. The variables E should be 1 for 8AM if, and only if, all values for X for that slot are zero. Similar constraints may be defined for the rest of the slots on Tuesday. Two selector variables may then be added. One selector variable may be added for the CNF constraints describing the absence of Adam on Monday. One selector variable may be added for the cardinality and CNF constraints describing the fact that Adam wants to rest at least in 2 slots.

In one example, two sets of constraints may contradict because Adam has to give at least 5 lessons on Monday and Tuesday (e.g., an absence on Monday means that Adam has to teach all slots on Tuesday, which contradicts the second constraint). In this example, the two RMA constraints may be presented to the user. The user may eliminate one of the constraints and/or relax the constraints. For example, the constraints may be relaxed by requiring that Adam teach at least 2 lessons on Monday.

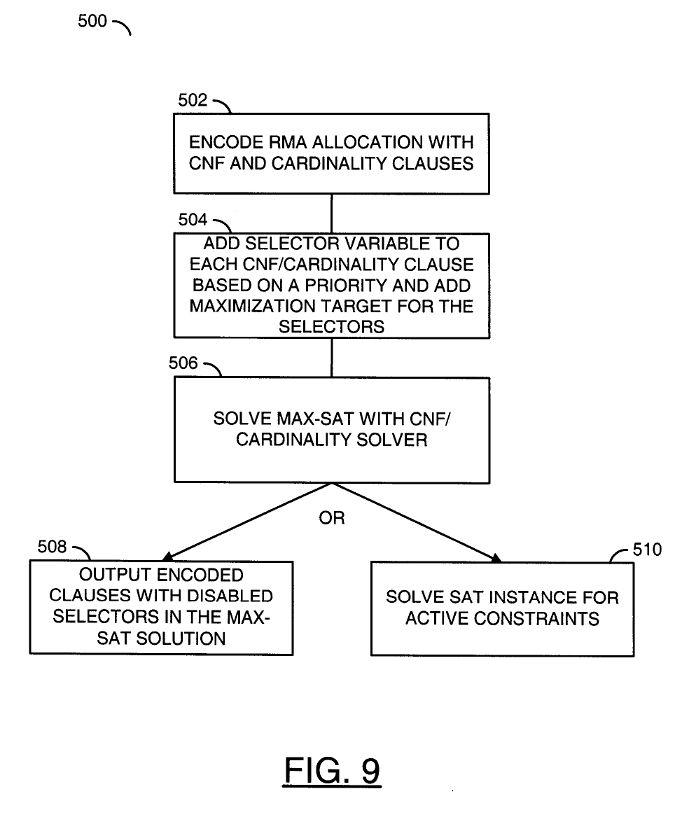

Referring to FIG. 9, a flow diagram illustrating a process 500 is shown. The process 500 generally comprises a step (or state) 502, a step (or state) 504, a step (or state) 506, a step (or state) 508, and a step (or state) 510. The state 502 may encode a resource management and allocation (RMA) allocation with conjunctive normal form (CNF) and cardinality clauses. The state 504 may add a selector variable to each group of clauses (e.g., the cardinality clause and the CNF clause) based on a priority. The state 504 may add a maximization target for the selectors. The state 506 may solve a maximum satisfiability (MAX-SAT) with a CNF/cardinality solver. The state 508 may present an output (e.g., the encoded clauses) with disabled selectors in the MAX-SAT solution. The state 510 may solve the SAT instance for the active constraints.

Often, RMA constraints are assigned priorities. For example, a weighted version of MAX-SAT may be used that maximizes a target (e.g., w₁s₁₊ w₂s_{2+ . . .+} wₖsₖ, where wᵢ is the weight of RMA constraint i). In this example, the user may relax and/or remove the contradicting constraints or a satisfying solution to the constraints activated by MAX-SAT may be presented.

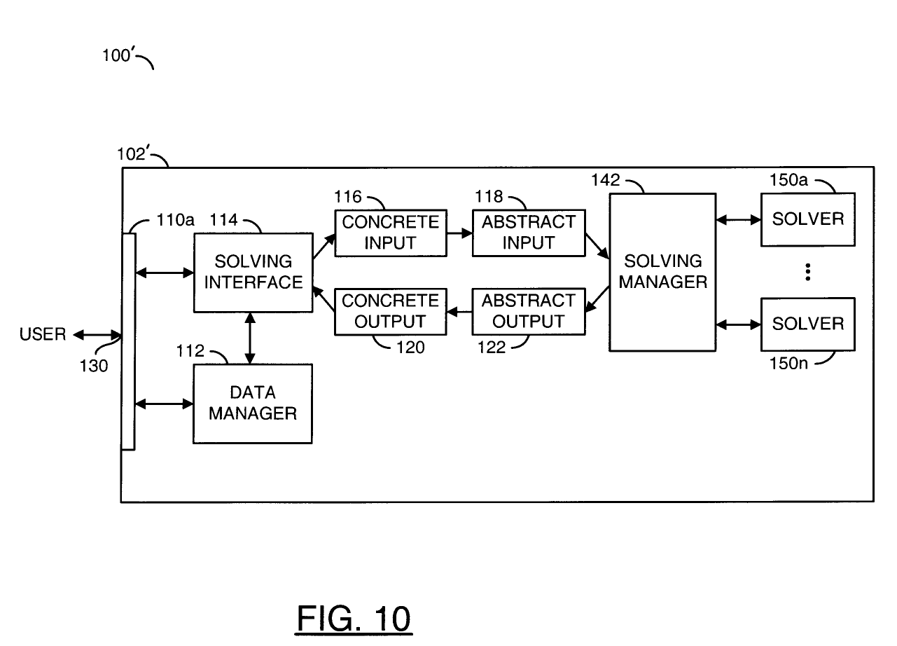

Referring to FIG. 10, a block diagram of a system 100′ is shown. The system 100′ generally comprises a block (or module) 102′. The block 102′ may be implemented as a client block (or application). The application block 102′ generally comprises the interface 110a, the solving interface 114, the data manager 112, the concrete input 116, the abstract input 118, the concrete output 120, the abstract output 122, the solving manager 142, and the solvers 150a-150n. The solving manager 142 and the solvers 150a-150n may be implemented as part of the application block 102′. In one example, the system 100′ may directly solve a resource and management allocation (RMA) problem. The solving manager 142 may be implemented as hardware in the application block 102′. In one example, the solving manager 142 may be implemented as software. The solving manager 142 and the solvers 150a-150n may be implemented as hardware, software, or a combination of hardware and software in the application block 102′.

The functions performed by the diagrams of FIGS. 6-9 may be implemented using one or more of a conventional general purpose processor, digital computer, microprocessor, microcontroller, RISC (reduced instruction set computer) processor, CISC (complex instruction set computer) processor, SMID (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products) or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the spirit and scope of the invention.

1. A system comprising:
a first module configured to generate (i) a first set of data stored internally and (ii) a second set of data configured to be processed externally, in response to an input signal, wherein said second set of data contains information about a problem to be solved without disclosing confidential information; and
a second module configured to (i) process said second set of data internally when in a first mode and (ii) distribute said second set of data to one or more external processors when in a second mode.

2. The system according to claim 1, wherein said first set of data comprises concrete data.

3. The system according to claim 1, wherein said second set of data comprises abstract data.

4. The system according to claim 1, wherein said first set of data is encoded with a conjunctive normal form (CNF) clause.

5. The system according to claim 1, wherein said first set of data is encoded with a cardinality clause.

6. The system according to claim 1, further comprises:
a third module comprising a pool of said external processors accessible by said second module through a network.

7. The system according to claim 6, wherein said third module comprises a pool of resources.

8. The system according to claim 1, wherein said first module comprises a client side application.

9. The system according to claim 1, wherein said second module comprises a server side manager.

10. The system according to claim 1, wherein said first module accesses said second module over an internal server network.

11. The system according to claim 1, wherein said second module further comprises a solving manager configured to determine whether to process said second set of data in said first mode or said second mode.

12. The system according to claim 11, wherein said external processors are accessible over a public network.

13. The system according to claim 1, wherein said external processors solve said problem.

14. The system according to claim 1, wherein said first module is configured to present a solution to said problem.

15. The system according to claim 1, wherein said second module distributes said problem to two or more of said external processors.
